(19) United States
(12) Patent Application Publication
(10) Pub. No.: US 2006/0087086 A1
(43) Pub. Date: Apr. 27, 2006

(54) Sealing device for maxi rotary cylinder

(76) Inventor: Kouichi Sakakibara, Gifu-Ken (JP)

Correspondence Address: Sakakibara Kouichi, 1-103-1 Sugaminami Hotsu-cho, Hashima-shi Gifu-ken, 501-6335, JP

(21) Appl. No.: 10/510,461

(22) PCT Filed: Aug. 5, 2003
(86) PCT No.: PCT/JP03/09964

§ 371 Date: Oct. 6, 2004

(30) Foreign Application Priority Data
Sep. 30, 2002 (JP) 2002-334415
Feb. 24, 2003 (JP) 2003-108447

(51) Int. Cl. F16J 15/02

(52) U.S. Cl. 277/628

(57) ABSTRACT

A sealing device has a plurality of L-shaped seals each of which has one round surface and the other flat surface contacted on outer sidewall of the powered rotary cylinder and on outer sidewall of the shell respectively at the intersection. One L-shaped seal is crossed into another L-shaped seal on the sides. The L-shaped seal with a hole on the flat surface is fitted by a slide on the fixed shell. The seals crossed freely on these three-dimensional sealing surfaces (with measures for tension) are arranged in a circumferential direction of the cylinder.

### BACKGROUND OF THE INVENTION

1. Field of the Invention

This invention relates to a sealing device for a maxi rotary cylinder such as a rotary kiln, a rotary cooler and a rotary drier, etc. used in industrial waste destruction, limestone-, alumina-, coke-, cement-, carbide-making, and the like. The sealing device is attached to a one- or two-tier cylinder and fixed shell (housing) to seal air, gas, and so on.

2. Description of the Related Art

Conventionally, a variety of air (gas) seals such as labyrinth seals, band seals, band seals with packing, seals for dividing spring pressure and the combinations of them are used for a rotary kiln and fixed shell (housing) in cement calcinations, paper sludge, and so on. They are suggested in official patent reports and other things.

### BRIEF SUMMARY OF THE INVENTION

It is an object of the invention to provide a sealing device for a maxi rotary cylinder that withstands higher temperatures and a greater amount of axial movement with the maximum sealing effectiveness at a small cost and minimizes degeneration with no maintenance. On the contrary, the above-mentioned labyrinth seals, various kinds of band seals or even the combinations of them don't have enough sealing effectiveness. Besides, the seals near the inner part of the rotary two-tier cylinder and the combustion chamber are in higher temperatures for combustion, carbonization, calcinations, and so on to prevent pollution by dioxin, etc. recently. Moreover, concerning contemporary larger-sized cylinders, formation of a true circle is very difficult. Therefore, conventional seals degenerate easily because of higher temperatures and a greater amount of axial movement with transformation by the weight.

According to a first aspect of the invention, there is provided a sealing device comprising a plurality of L-shaped seals each of which has one round surface and the other flat surface contacted on outer sidewall of the powered rotary cylinder and on outer sidewall of the fixed shell respectively at the intersection. One L-shaped seal is crossed into another L-shaped seal on the sides. The L-shaped seal with a hole on the flat surface is fitted by a slide on the fixed shell. The seals crossed freely on these three-dimensional sealing surfaces are arranged in a circumferential direction of the cylinder.

According to a second aspect of the invention, there is provided a sealing device the L-shaped seal of which has a ditch for presence of sealing material on the sealing surface.

According to a third aspect of the invention, there is provided a sealing device the L- shaped seal of which has measures for tension at cross sections.

According to a fourth aspect of the invention, there is provided a sealing device with the L-shaped seals each of which has one round surface and the other flat surface contacted on outer sidewall of the powered rotary cylinder and on outer sidewall of the fixed shell respectively at the intersection. One end of both surfaces of one L-shaped seal is concavo and the other end is convex. The concavo of one L-shaped seal and the convex of another L-shaped seal are crossed lengthwise and widthwise on the sides. The L-shaped seal with a hole on the flat surface is fitted by a slide on the fixed shell. The seals are always crossed on these three-dimensional sealing surfaces tightly, especially lengthwise in a circumferential direction of the cylinder.

According to a fifth aspect of the invention, there is provided a sealing device that has some L-shaped seals with both concavo ends of one round surface and the other flat surface, and other L-shaped seals with both convex ends of both surfaces. Either L-shaped seal has a hole on the flat surface.

According to a sixth aspect of the invention, there is provided a sealing device the L-shaped seal of which has both convex ends without a hole on the flat surface.

According to a seventh aspect of the invention, there is provided a sealing device that has some L-shaped seals with a hole and other L-shaped seals without a hole on the flat surface.

According to an eighth aspect of the invention, there is provided a sealing device the L-shaped seal of which has a ditch for presence of sealing material.

According to a ninth aspect of the invention, there is provided a sealing device the L-shaped seal of which has a sealing material-pressing out gadget over the ditch.

According to a tenth aspect of the invention, there is provided a sealing device the L-shaped seal of which has spring, weights or both of them as measures for tension at cross sections.

According to an eleventh aspect of the invention, there is provided a sealing device the L-shaped seal of which has oil-caps, grease-nipples or both of them.

According to a twelfth aspect of the invention, there is provided a sealing device the L-shaped seal of which has a ditch for presence of oil on the sealing surface.

In the above-mentioned sealing device, the L-shaped seal has one round surface and the other flat surface contacted tightly on outer sidewall of the powered rotary cylinder and on outer sidewall of-the fixed shell respectively at the intersection. One L-shaped seal is crossed into another L-shaped seal lengthwise and widthwise on the sides. The seals are always crossed on these three-dimensional sealing surfaces tightly especially lengthwise in a circumferential direction of the cylinder. Moreover, the movements with the width of a slide (by a slide) in a hole on the flat surface strike the balance of convex and concavo of the axial movements of the rotary cylinder. Furthermore, the seal has compression spring as measures for tension for sealing effectiveness at cross sections. In addition, a weight is fitted at the bottom of one ring of dual rings out of a chain or a wire on the circumference of the cylinder instead of spring in high temperatures.

Further objects and advantages of the invention will be apparent from the following description, reference being had to the accompanying drawings, wherein preferred embodiments of the invention are clearly shown.

### BRIEF DESCRIPTION OF THE DRAWINGS

FIG. 1 is an explanatory drawing showing main parts of a sealing device according to a first embodiment of the invention that is installed on a maxi rotary cylinder.

FIG. 2 (2-1) is a partially perspective view of a seal and (2-2) is a partially cut-away view of a ditch on one round surface of the L-shaped seal contacted on the rotary cylinder according to the first embodiment and a second embodiment of the invention.

FIG. 3 is an explanatory drawing showing a front side of movements with the width of a slide in a hole on the seal according to the first embodiment of the invention.

FIG. 4 is a partially cut-away view showing the seal fitted by a slide according to the first embodiment of the invention.

FIG. 5 is a partially cut-away view showing the way of weighting the seals with dual rings as measures for tension according to a third embodiment of the invention.

FIG. 6 is a partially cut-away view showing a balance system as measures for tension of the seals according to a fourth embodiment of the invention.

FIG. 7 is a partially cut-away view showing an unbalance system as measures for tension of the seals according to the fourth embodiment of the invention.

FIG. 8 is a partially cut-away view showing a separate system as measures for tension of the seals according to a fifth embodiment of the invention.

FIG. 9 (9-1) is a perspective view of a free joint metal for the seals, (9-2) is a perspective view of elastic body (spring) as measures for tension and (9-3) is an overall explanatory drawing of a free joint bolt and nut (for manual adjustment) according to the first embodiment of the invention.

FIG. 10 (10-1) is a side view of free joint chain (including wire, and so on), (10-2) is a side view of elastic body (spring) as measures for tension and (10-3) is an overall explanatory drawing of a linking area with a side view of a free joint turn-buckle (for manual adjustment) according to the first embodiment of the invention.

FIG. 11 is a partially cut-away view showing how each of some three-dimensional seals which has one flat surface and the other round surface with concavo in both ends is crossed tightly on the sides with each of other three-dimensional seals with convex in both ends according to other modifications of the invention.

FIG. 12 is a partially cut-away view of a (manual) gadget with a bolt and (w) nut system for pressing out (sealing material) over the ditch of the L-shaped seal which has one flat surface and the other round surface contacted on the fixed shell and the rotary cylinder respectively at the intersection according to the second embodiment of the invention.

FIG. 13 is a partially cut-away view of a safe gadget with a pin and three-tier spring (as measures for tension) for pressing out (sealing material automatically) over the ditch of the L-shaped seal which has one round surface and the other flat surface contacted on the rotary cylinder and a fixed shell respectively at the intersection according to the second embodiment of the invention.

### ILLUSTRATIONS

1. fixed shell
2. seal
3. hole for slide
4. hole on fixed shell
5. (rotary) cylinder
6. nut of joint metal for seals
7. ditch on seal (for elastic body)
8. plural- (three-) dimensional sealing surfaces
9. seal-pressing plate
10. bolt tap
11. balanced slide bush
12. weight
13. upper part of sealing circle
14. lower part of sealing circle
15. fulcrum (including pulleys and hooks, etc.)
16. wire for raising seals (including chain)
17. bolt for pressing out sealing material
18. pin for pressing out sealing material
19. attachment
20. free joint metal for seals
21. chain (including wire)
22. turn-buckle
23. hook bolt
24. partially cut-away view showing how each of some three-dimensional seals with concavo in both ends is crossed into each of other three-dimensional seals with convex in both ends (on the flat surface and the round surface.)
[cf. claim 1 and 5]
25. spring fastener
26. sealing material
27. spring
28. w-nut
29. vertical side
30. parting line (including 29,)

### DETAILED DESCRIPTION OF THE INVENTION

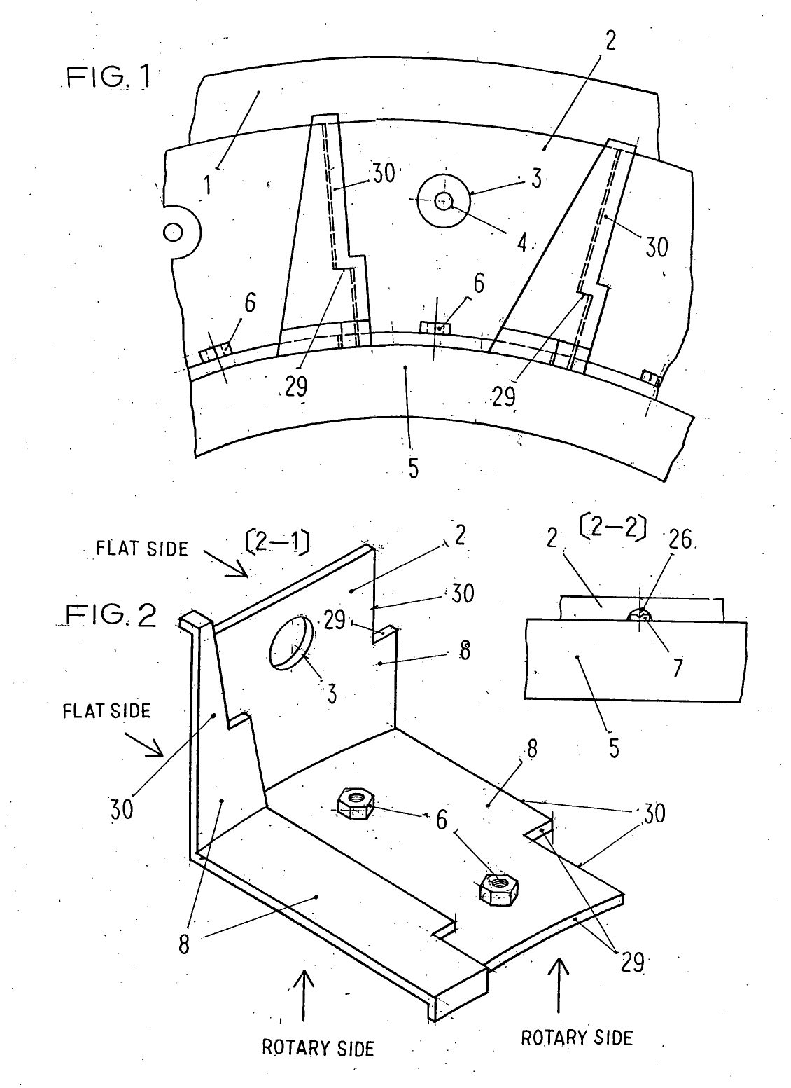

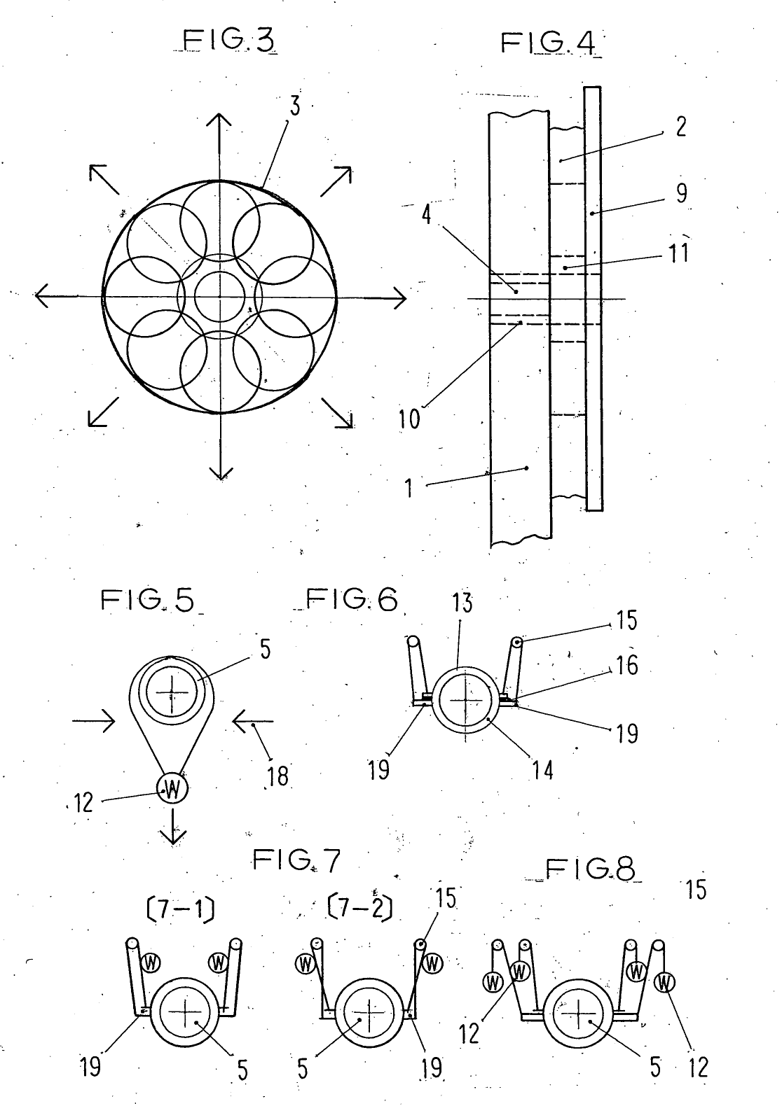

Several embodiments of the invention are described hereunder referring to the attached drawings. FIG. 1 is an explanatory drawing showing main parts of the sealing device. FIG. 2 (2-1) is a partially perspective view of a seal and (2-2) is a partially cut-away view of a ditch for presence of elastic sealing material on one round surface of the L-shaped seal contacted on the cylinder. (The same drawing of the other flat surface contacted on the fixed shell is omitted.) FIG. 3 is a partially explanatory drawing showing the directions of movements with the width of a slide in a hole on the seal. FIG. 4 is a partially cut-away view showing the seal fitted by a slide and FIG. 5, 6, 7 and 8 are partially cut-away views showing weight systems as measures for tension of the seals.

### First Embodiment

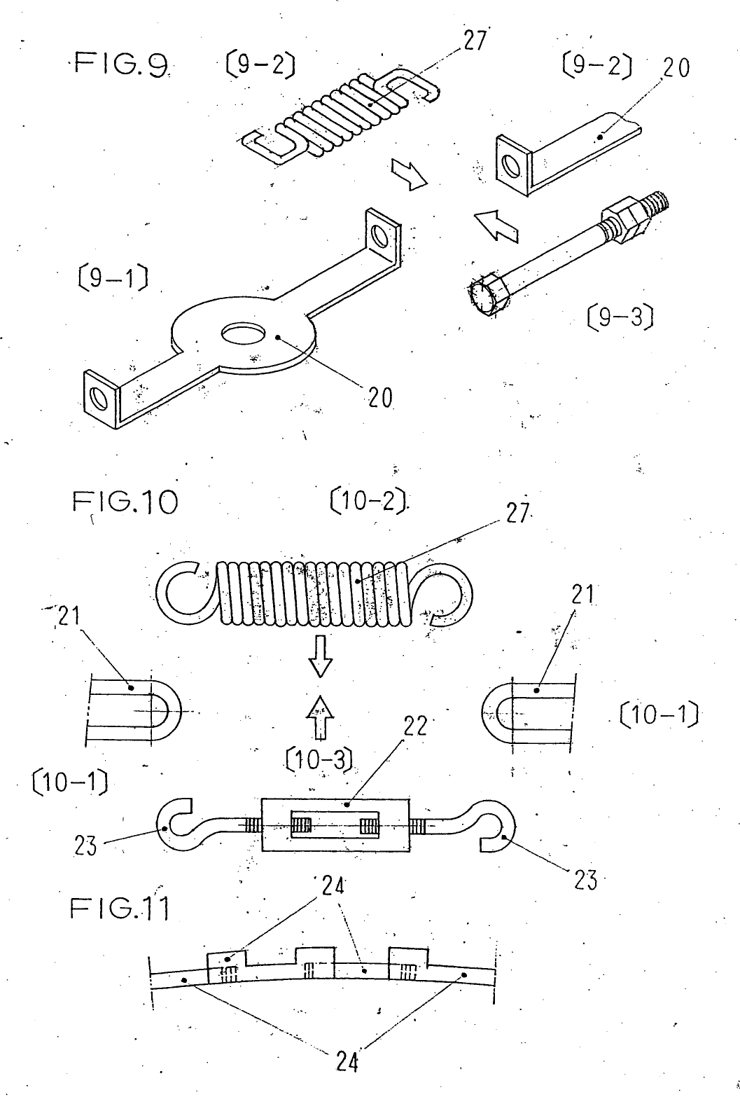

Referring to FIG. 1, a sealing device according to a first embodiment of the invention has a plurality of L-shaped seals (2) each of which has one round surface and the other flat surface contacted on the cylinder (5) and on the fixed shell (1) respectively at the intersection. The seal is fitted by a slide (with a bolt) in a hole (FIG. 1(4) and FIG. 4 (4)) on the fixed shell. The seal has balanced slide bushes (FIG. 4 (11)) to slide up and down, etc. smoothly and the seal is bolted on the seal-pressing plate (FIG. 4 (9)). Basically, the bush is as thick as the seal, but the thickness of the bush is adjusted for a slide. Then, the plural- (three-) dimensional sealing surfaces (FIG. 2 (8)) of one seal are crossed into the sealing surfaces of another seal with nuts of joint metals (FIG. 1, FIG. 2 (6)) and joint metals (FIG. 9 (9-1)) for a circumference or plural circumferences of the cylinder, if necessary. The seals may be crossed freely and tightly with a circle of flexible wire or chain, etc.

In these cases, to adjust the circumference, as shown in FIG. 9 and FIG. 10, bolts and nuts etc., may be provided as adjustment gadgets (not measures for tension but fixed ones for manual adjustment) to loose metal with the passage of time and to lengthen metal in high temperatures, because the seals near the inner part of the two-tier cylinder are in such high temperatures that compression spring, etc. as measures for tension to contact the seals tightly on the cylinder (especially without clearances on the lower part of the circle by the weight) are degenerated for a short time.

Regardless of clearances on the sides of the seals (widthwise on the round surface and the flat surface in the circumferential direction of the cylinder) in high temperatures, the practical sealing is very tight because of the three-dimensional seals with one flat surface and the other round surface contacted on the fixed shell and the cylinder respectively and the sealing of the sides is always tight lengthwise even in high temperatures. Therefore, the round surface of the cylinder and the flat surface of the fixed shell have very ideal sealing conditions. Moreover, the size of the hole for a slide on the seal accommodates the width of axial movements (The width of axial movements=the diameter of the hole for a slide—the outside diameter of the balanced slide bush.)

Specifically, stainless SUS 310S, heat-resistant stainless or ceramic is used because the seals (near the inner part of the two-tier cylinder and the combustion chamber) become about 1200° C.

### Second Embodiment

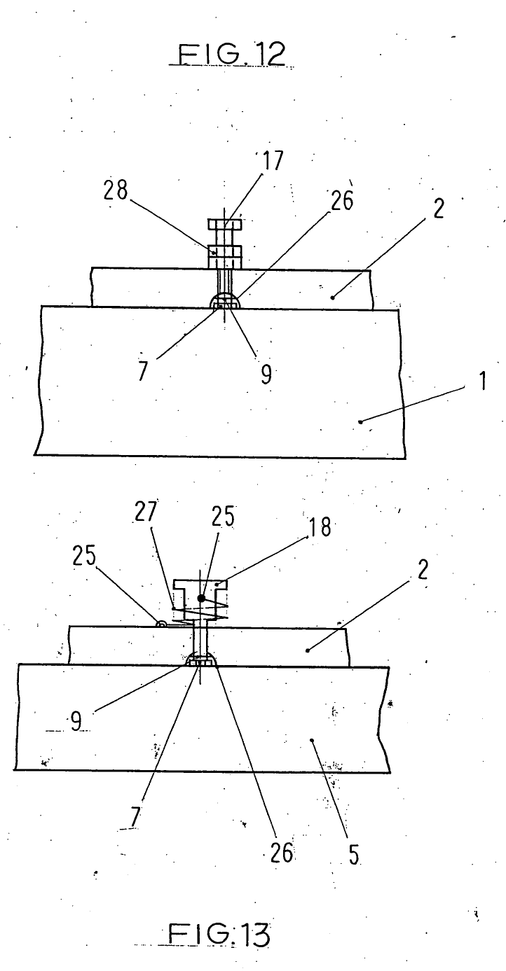

As shown in FIG. 2 (2-2), the second embodiment of the sealing device incorporates elastic sealing material on the sealing surface, which can seal air more effectively than the first embodiment. The above-mentioned sealing uses the general natural pressure of the sealing, while the sealing in FIG. 12 uses a bolt-adjustment type and the sealing in FIG. 13 uses a type with measures for tension (an automatic adjustment together with spring pressure).

### Third Embodiment

A sealing device according to the third embodiment provides not manual but automatic measures for tension as mentioned afore, generally at one or more-halfway cross sections so that the seals could be always contacted very tightly on the cylinder. Instead of this spring in high temperatures, as mentioned afore, a weight for sealing is fitted at the bottom of one ring of dual rings out of a chain or a wire on the circumference of the cylinder. To contact more tightly on the cylinder, both of them may be used.

### Fourth Embodiment

Referring to FIG. 6, in the fourth embodiment, a free balance system is used. The seals in the upper part and the lower part of the sealing circle are separated with the attachments (19), linked with each other (by chain or wire, etc.) and balanced in weight on fulcrums (15) (including pulleys and hooks, etc. like a pair of scales) to minimize wear of the seals with the less pressure (the bare minimum) on the sealing surface on the cylinder.

As shown in FIG. 7 (7-1) and (7-2), the seals in the upper part and the lower part of the sealing circle are linked with each other through fulcrums to put a little more pressure on the lower part of the circle. Two drawings of FIG. 7 show the weight systems.

### Fifth Embodiment

Referring to FIG. 8, in the fifth embodiment, a separate balance system may be used. The upper part and the lower part of the sealing circle may be balanced in weight on each fulcrum in all kinds of conditions such as machines, raw materials, weights, temperatures, speeds, and so on.

### Other Modifications

A sealing device is used for our rotary kiln the diameter of which is 1800 mm (the inner cylinder's diameter is 1200 mm) and the width of axial movements of the outer cylinder is about 30 mm, 1.6%. Thirty-six seals are used for a circumference of the cylinder and the cross angle (the angle of crossing seals) is 10°. As mentioned afore, many kinds of seals in cross sections, etc. may be used. Here, the first embodiment of the sealing device shows the point that one end of one round surface and the other flat surface of one three-dimensional seal is crossed with one end of both surfaces of another seal on the sides to seal (air) even in axial movements.

Consequently, uncalculating chemical changes and deterioration of effectiveness because of gas (air, etc.) leak in combustion, carbonization, calcinations, etc. are minimized. Moreover, very stable operations, fixed qualities and diminution of fuel expenses for oil, etc. are expected in factories which used to have gas leak because of seal-damages in a great amount of axial movement and higher temperatures. The long-life seals at a small cost and with no maintenance will come into wide use with rapidity.

The preferred embodiments described herein are illustrative and not restrictive, the scope of the invention being indicated in the appended claims and all variations that come within the meaning of the claims are intended to be embraced therein.

1. A sealing device comprising a plurality of L-shaped seals, one round surface and the other flat surface being contacted on outer sidewall of the powered rotary cylinder and on outer sidewall of the shell respectively at the intersection, one L-shaped seal being crossed into another L-shaped seal on the sides, the L-shaped seal with a hole on the flat surface being fitted by a slide on the fixed shell, and the seals crossed freely on these three-dimensional sealing surfaces being arranged in a circumferential direction of the cylinder.

2. A sealing device according to claim 1, in which the L-shaped seal has a ditch for presence of sealing material on the sealing surface.

3. A sealing device according to claim 1 and 2, in which the L-shaped seal has measures for tension at cross sections.

4. A sealing device according to claim 1, 2 and 3, in which:
the L-shaped seal one round surface and the other flat surface contacted on outer sidewall of the powered rotary cylinder and on outer sidewall of the fixed shell respectively at the intersection;
one end of both surfaces of the L-shaped seal is concavo and the other end is convex, and the concavo of one L-shaped seal and the convex of another L-shaped seal are crossed lengthwise and widthwise;
the L-shaped seal with a hole on the flat surface is fitted by a slide on the fixed shell; and
the L-shaped seals crossed on these three-dimensional sealing surfaces are always arranged tightly, especially lengthwise in a circumferential direction of the cylinder.

5. A sealing device according to claim 1, 2, 3, and 4, in which;
both ends of one round surface and the other flat surface of some L-shaped seals are concavo and both ends of one round surface and the other flat surface of other L-shaped seals are convex; and
either L-shaped seal has a hole on the flat surface.

6. A sealing device according to claim 5, in which the L-shaped seal with both convex ends doesn't have a hole on the flat surface.

7. A sealing device according to claim 1, 2, 3, 4 and 5 in which each of some L-shaped seals and other L-shaped seals has a hole and no hole respectively on the flat surface.

8. A sealing device according to claim 1, 2, 3, 4, 5, 6 and 7, in which the L-shaped seal has a ditch for presence of sealing material.

9. A sealing device according to claim 8, in which the L-shaped seal has a sealing material-pressing out gadget over the ditch.

10. A sealing device according to claim 1, 2, 3, 4, 5, 6, 7, 8 and 9, in which the L-shaped seals have spring, weights or both spring and weights as measures for tension at cross sections.

11. A sealing device according to claim 1, 2, 3, 4, 5, 6, 7, 8, 9 and 10, in which the L-shaped seals have oil-caps, grease-nipples or both of them.

12. A sealing device according to claim 1, 2, 3, 4, 5, 6, 7, 8, 9, 10 and 11, in which the L-shaped seal has a ditch for presence of oil on the sealing surface.
